(19) United States
(12) Patent Application Publication
(10) Pub. No.: US 2012/0024798 A1
(43) Pub. Date: Feb. 2, 2012

(54) Selenium Removal Using Chemical Oxidation and Biological Reduction

(76) Inventors: Timothy Michael PICKETT, Salt Lake City, UT (US); Yanguo Ma, Salt Lake City, UT (US); Jill Sonstegard, Layton, UT (US)

(21) Appl. No.: 12/844,053

(22) Filed: Jul. 27, 2010

(51) Int. Cl. C02F 9/04; C02F 3/00; C02F 1/70; C02F 1/72; C02F 1/58

(52) U.S. Cl. 210/719; 210/205

(57) ABSTRACT

Selenium in the form of a reduced species such as selenocyanate is oxidized to produce an oxidized selenium species such as selenate or selenite, and then a biological reduction process is used to remove selenium from the oxidized selenium species. In an example, a chemical oxidant is added to a wastewater containing selenocyanate to produce selenate and selenite. The partially treated wastewater is then fed to a reactor containing a fixed media supporting a biofilm with selenium reducing organisms. The selenium in the selenate and selenite is reduced to an insoluble form of selenium, such as elemental selenium, which precipitates from the wastewater.

### FIELD

This specification relates to treating water that contains a reduced form of selenium such as selenocyanate to reduce its total selenium content.

### BACKGROUND

The following paragraphs are not an admission that any of the information below is common general knowledge or citable as prior art.

Selenium is an essential trace element, but becomes toxic at very low concentrations. Selenium accumulates in the bodies of plants and fish that live in selenium-contaminated water and in the bodies of wildlife and people that eat those pants and fish. In people, elevated selenium concentrations may cause neurological damage and hair and nail loss. In the US, discharge limits for selenium may be set at between 10 ppb and 50 ppb.

Selenium in the form of selenocyanate (SeCN—) can be present in wastewater produced by oil refineries and coal fired generating plants, including in particular refineries processing oil from stocks produced by High Pressure Injection (HPI) and clean coal plants using an integrated gasification combined cycle (IGCC). There is a need for treatment methods that allow these industries to reduce the amount of SeCN— in their wastewater to comply with selenium discharge regulations, and a need to protect the environment from hazardous discharges of selenium.

Selenium in the form of selenate and selenite has been treated in biological reactors, for example as described in U.S. Pat. No. 6,183,644 and International Publication Number WO 2007/012181, and as used in ABMet™ reactors sold by the General Electric Company. However, the ABMet™ system is not able to remove reduced selenium species such as selenocyanate but these systems require a large area of available land. Selenocyanate may also be treated by precipitation using additives such as elemental iron or copper (II) salts. These processes consume the additives used to cause precipitation and create a large amount of waste sludge. There is therefore a need for improved methods of treating wastewater that contains selenocyante.

### SUMMARY

The following summary is intended to introduce the reader to this specification but not to define any invention.

An apparatus and process described herein may be used to reduce the total selenium content of water containing a reduced selenium species such as selenocyanate. In brief, the reduced selenium species are oxidized to produce an oxidized selenium species (primarily selenate or selenite) and then a biological reduction process is used to remove selenium from the oxidized selenium species. The selenium concentration in the water is decreased, preferably to below discharge regulation limits.

In an exemplary process, a chemical oxidant is added to a wastewater containing selenocyanate. The oxidant may be, for example, NaOCl, KMnO₄, K₂FeO₄, Na₂S₂O₈ or ClO₂. Selenate (SeO4-2), selenite (SeO3-2), or a mixture of them, are produced. The partially treated wastewater is then fed to a reactor containing a fixed media supporting a biofilm with selenium reducing organisms. In this reactor, selenium in the selenate and selenite is reduced to an insoluble form of selenium, such as elemental selenium, which precipitates from the wastewater. Precipitated selenium is retained in the reactor until removed, for example by periodically flushing the reactor and collecting the discharge.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic representation of a treatment system for removing selenium from water.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

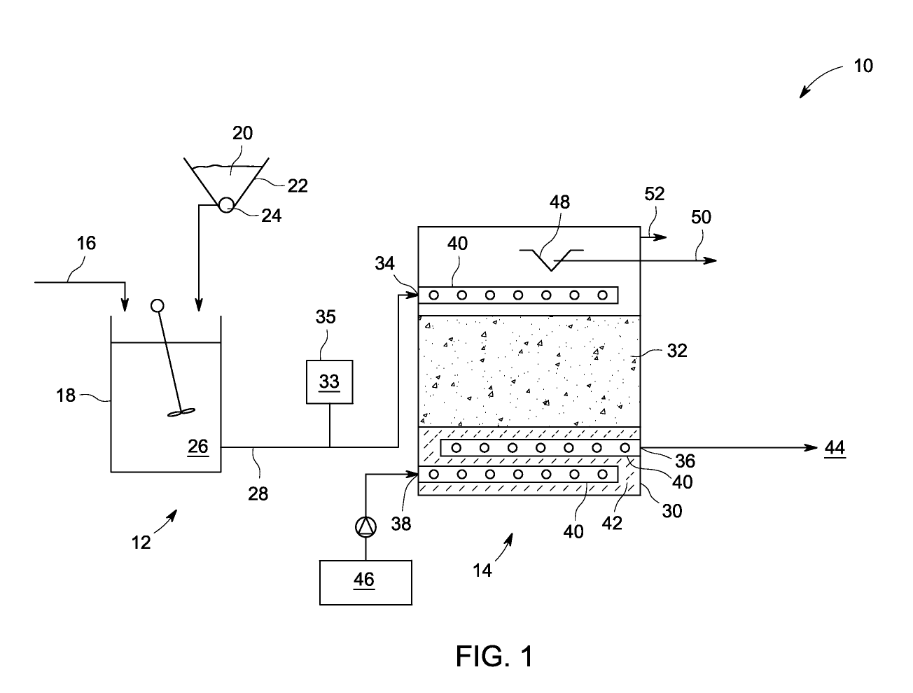

FIG. 1 shows a treatment system 10 having a pretreatment area 12 upstream of a biological treatment area 14. The treatment system 10 may be used to reduce the total selenium content of water containing a reduced selenium species such as selenocyanate. In the pretreatment area, the reduced selenium species is oxidized to produce an oxidized selenium species (selenate or selenite). In the downstream biological treatment area, a biological reduction process is used to remove selenium from the oxidized selenium species. The resulting effluent has a reduced total selenium concentration, preferably below discharge regulation limits. Although shown as a generally two-stage system, the elements of system 10, and corresponding process steps, may be integrated with other system elements or process steps to remove other pollutants from wastewater.

Feed 16, which may be a wastewater from an oil refinery or a coal-fired power plant, flows into mixing tank 18 of pretreatment area 12. Feed 16 contains a reduced selenium species such as selenocyanate. Depending on the source, feed 16 may contain 100 ppb or more or 1000 ppb or more of selenocyanate. A chemical oxidant 20 is fed from a hopper 22 by metered pump 24 into the tank 18. The oxidant 20 may be, for example, NaOCl, KMnO₄, K₂FeO₄, Na₂S₂O₈ or ClO₂. One or more of these oxidants, for example NaOCl or CLO₂, may be generated on-site for safety and reduced costs using a commercially available onsite generation system.

Mixing tank 18 operates as a completely stirred tank reactor (CSTR) mixing the feed 16 with the oxidant. The average detention time in the tank 18 may be 10 to 30 minutes. Alternately, the oxidant 20 may be mixed into a flowing stream of the feed 16 using an in-line mixer, optionally with a holding tank used to provide increased reaction time.

The oxidant 20 reacts with the selenocyanate in the tank 18 to form oxidized species of selenium such as selenate (SeO4-2) and selenite (SeO3-2). A pre-treated effluent 26 leaves the tank 18 through a transfer pipe 28. The pre-treated effluent 26 preferably contains less than the maximum permitted discharge concentration of selenium in the form of selenocyanate. For example, the pre-treated effluent 26 may have less than 50 ppb selenocyanate or less than 10 ppb selenocyanate. The remainder of the selenium in the pre-treated effluent 26 is primarily in the form of oxidized species of selenium.

For example, NaOCl, in a range of 50 to 500 mg/L, was added to 1 liter of water containing SeCN—. The water was mixed and allowed to react for 10-30 minutes while mixing. The water was then sampled for selenium speciation analysis. The results of two trials are shown in Table 1 below. “ND” in the charts indicates that the indicated chemical was not detected at the applied dilution. The results indicate that essentially all of the selenium contained in the water has been converted from SeCN— to other selenium species including Se (IV) and Se (VI).

TABLE 1

| | SeCN—, ppb | Se(IV), ppb | Se(VI), ppb |
|---|---|---|---|
| Trial 1 | | | |
| Original water | 120 | 16.3 | ND < 4.7 |
| Oxidized water | ND < 3.2 | 118 | ND < 1.8 |
| Trial 2 | | | |
| Original water | 1410 | 471 | 4.7 |
| Oxidized water | ND < 2.0 | 393 | 1740 |

Pre-treated effluent 26 flows through transfer pipe 28 to the biological treatment area 14. Biological treatment area 14 includes a reaction vessel 30 that supports a population of selenium reducing organisms, primarily facultative anaerobic bacteria. The organisms may be located in a fixed biofilm on a media bed 32. Reaction vessel 30 as shown is organized as a simple fixed media, single stage, downwards plug flow reactor. Optionally, the reaction vessel 30 may be configured for upwards flow and multiple stage reactors may also be used. Other types of reactors, including other types of fixed film reactors, may be used. For example, reaction vessel 30 may be a moving bed reactor or a fluidized bed reactor. A suitable commercially available system for the biological treatment area 14 is an ABMet™ reactor by GE Water and Process Technologies.

In the reaction vessel 30 shown, media bed 32 provides a location on which a population of microorganisms will grow and be retained within the reaction vessel. Activated carbon may be employed as the medium and provides a large surface area available for microbial growth. The activated carbon may be in the form of granular activated carbon (GAC) or pelletized activated carbon. Other media might be used, for example polymeric fibers, crushed stone, pumice, sand, plastic media or gravel.

The reaction vessel 30 has an upper port 34, a lower port 36 and a backwash port 38, each of which may be connected to a distribution system 40, for example one or more perforated horizontal pipes. Aggregate 42 may be installed around the distribution systems 40 below the bed 32 to aid in flow distribution while also preventing break through of media to the distribution systems 40.

During normal operation, pre-treated effluent 26 enters reaction vessel 30 through upper port 34 and flows downwards through media 32. Treated effluent 44 exits the reaction vessel through lower port 36. If an upwards flow is used, the upflow velocity under normal forward flow conditions may be maintained at about 5 ft/hr, which is well below the settling rate of the media, which for activated carbon is about 160 ft/hr. While passing through the media bed 32, selenium is removed from the wastewater by biological reduction of the oxidized selenium species to elemental selenium. A further description of this process and related information is provided below and in U.S. Pat. No. 6,183,644 and International Publication Number WO 2007/012181, both of which are incorporated herein in their entirety by this reference to them.

Selenium reducing organisms occur in nature and may populate the reaction vessel 30 through their own actions over time as the treatment system 10 is operated. However, the reaction vessel 30 can be populated faster by seeding the reaction vessel 30 with a culture of appropriate organisms that have been isolated and grown separately. Microbes that have demonstrated the ability to reduce oxidized selenium to elemental form include microbes of the genus Pseudomonas, Shewanella, Alcaligenes. At plant start-up, a seed culture of microbes may be supplied to seed the bed 32.

Following seeding with the desired microbial culture, the reaction vessel 30 may be operated in a recycle mode for several days to allow the microbes to attach while adding nutrients to the reaction vessel 30. After seeding, normal feed flow can be introduced.

Unless the feed water 16 contains other suitable matter, nutrients 33 should be added to the reaction vessel 30 during operation of the system 10. In the system 10 shown, nutrients 33 are added to the pre-treated effluent 26 from a nutrient tank 35 upstream of the reaction vessel 30. The nutrients 33 provide a carbon and energy source to support the growth and metabolism of the microorganisms in the reaction vessel 30. A molasses-based nutrient mixture may be used. The nutrients 33 may be chosen to provide a carbon: nitrogen:phosphorous ratio (CNP) of, for example, 100:10:1, when mixed with the feed. Nutrients 33 may be supplied, for example, at a rate of 0.2-0.4 gallons of nutrient per 1000 gallons of feed water 16. Optionally, the basic mixture may be supplemented with micronutrients and other components to promote stable growth for the target microbial population.

Microorganisms in the reaction vessel 30 reduce selenium in the pre-treated effluent 26 from an oxidized state to elemental form. The elemental selenium precipitates from the wastewater in the form of stable granular nanospheres in and around the microorganisms. Since the microorganisms are attached to the media, the selenium is likewise retained within the media bed 32 until removed by a flushing procedure that will be described further below.

The microorganisms typically operate under anaerobic conditions. With a generally plug flow regime, a redox gradient develops through the media bed 32. This gradient can be controlled if necessary by adjusting the rate of nutrient 32 addition or hydraulic retention time (HRT) or both in the media bed 32. In general, HRT may be altered at the design stage by choosing the media bed 32 dimensions in relation to the expected feed flow, for example by changing the dimensions of the media bed 32 or the number of media beds 32 in series or parallel. The HRT may be, for example, in the range from 0.5 hours to 12 hours. The rate of nutrient 32 addition may be varies after a system 10 is built and operating to adjust the redox gradient either to provide better performance under steady feed 16 flow conditions or to account for variations in the flow rate or composition of the feed 16. Higher levels of nutrient addition will drive redox lower; reducing nutrient addition will cause redox level to rise. Optionally, nutrients 32 may be added within a media bed 32 or between multiple media beds 32. The oxygen reduction potential (ORP) in at least a portion of a media bed 32 intended to reduce selenium may be −50 mV to −200 mV. ORP sensors (not shown) may be used near one or both of the ports 34, 36 or in the media bed 32, or both, to assist in controlling the system 10 such that ORP of the treated effluent 44 is −50 mV or less and treated effluent 44 has a total selenium concentration below the desired or regulated discharge limit.

Some gasses may be produced in the reaction vessel 30 during operation. These gasses collect in a headspace of the reaction vessel. A gas outlet 52 may be used to release these gases to the atmosphere or collect them for further treatment.

As elemental selenium, and possibly other solids, accumulate in the media bed 32, the pressure drop across the media bed 32 will increase. At a selected time interval or pressure drop set point, backwash water 46 is pumped into backwash port 38 to flush or backwash the media bed 32. Backwash water 46 may be feed water 16, or other water that preferably will not harm the microorganisms. The upflow velocity during backwashing may be about 80 ft/hour, or in a range that would be used in activated carbon fluidized bed systems, but below the settling rate of the media particles.

The upflow velocity applied during flushing may result in an upward expansion of the media bed 32 by up to 30%. An upper distribution system 40, if located in the bed expansion area, may have small holes or be covered with a screen to keep media from entering it, and ports 34, 36 may be closed during flushing. During the backwash, excessive biomass growth attached to the media and solids that have been removed from the water, including selenium nanospheres, are entrained in the backwash water 46. The backwash water 46 and entrained solids are removed through troughs 48 located above the expected media expansion area and connected to a backwash effluent line 50.

Flushing may be required from between once every two weeks to only a few times each year, for example once a month. Flushing may take, for example, 30 minutes. Spent backwash water 46 may be sent to a liquid/solid separation device such as a clarifier. Cleaned backwash water 46 may be sent to the head of the system 10 or to another water treatment plant. Sludge from the clarifier may be de-watered and sent to a toxic sludge disposal system or processed further to extract the elemental selenium for safe disposal or use in industry. Although some sludge is produced, the amount is greatly reduced relative to, for example, an iron precipitation method of selenium treatment.

The system 10 and process described above are intended to provide an example or a selenium treatment process and apparatus and not to limit or define any claimed invention. Other treatment systems or process may be used within the scope of an invention defined in the following claims.

While the above description provides examples of one or more processes or apparatuses, it will be appreciated that other processes or apparatuses may be within the scope of the accompanying claims.

1. A process for treating water containing a reduced species of selenium comprising steps of,
a) oxidizing the reduced species of selenium in the water to produce an oxidized selenium species in the water;
b) reducing the oxidized selenium species in the water via biological reduction to produce a precipitate comprising selenium in the water; and,
c) separating the water from the precipitate comprising selenium.

2. The process of claim 1 wherein the reduced species of selenium comprises selenocyanate.

3. The process of claim 2 wherein the oxidized selenium species comprises one or more of selenate and selenite.

4. The process of claim 3 wherein step a) comprises mixing a chemical oxidant into the water.

5. The process of claim 3 wherein the chemical oxidant comprises one or more of NaOCl, KMnO₄, K₂FeO₄, Na₂S₂O₈ or ClO₂.

6. The process of claim 5 wherein steps b) and c) comprise flowing the water through a reactor containing a fixed film of selenium reducing organisms.

7. The process of claim 6 further comprising adding a nutrient to the water to produce an ORP in water in contact with the fixed film of −50 mV or less.

8. An apparatus for treating water containing a reduced species of selenium comprising,
a) a vessel for receiving water to be treated;
b) a supply of a chemical oxidant;
c) a system for mixing the chemical oxidant into water in the vessel; and,
d) a reactor adapted to receive water from the vessel and flow the water through a media bed.
